(19) United States
(12) Patent Application Publication
(10) Pub. No.: US 2008/0109334 A1
(43) Pub. Date: May 8, 2008

(54) METHOD AND SYSTEM FOR PROVIDING PAYMENT CODES

(76) Inventors: Mark K. LEWIS, Atlanta, GA (US); Ricky Loftsgard, Clive, IA (US); Kasra Naderi, Atlanta, GA (US); Richard C. Potter, Fayetteville, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/556,344

(22) Filed: Nov. 3, 2006

(51) Int. Cl. G06Q 40/00

(52) U.S. Cl. 705/35; 705/1

(57) ABSTRACT

Methods for providing payment codes to borrowers are disclosed. One method, among others, includes providing payment codes through at least one self-service channel. The borrowers may retrieve their payment codes through the at least one self-service channel without the assistance of another person.

### TECHNICAL FIELD

The present invention is generally related to financial services and, more particularly, is related to a method and system for providing payment codes.

### BACKGROUND OF THE INVENTION

Today, many merchants provide financing to their customers. In other words, the merchants sell the product to the consumer and the consumer pays for the product over time on a payment plan. Typically, merchants may finance consumers to help move their inventory. Car dealers are an example of a class of merchants that provide financing to customers. Merchants who provide financing loans have competing interests. On the one hand, merchants want to provide financing so as to move inventory and gain the profit from selling the inventory. On the other hand, merchants need to be selective with regards to whom they provide financing. The loss caused from a single default can destroy the profit from multiple sales.

To alleviate or reduce the risk of providing financing, merchants will run credit checks on prospective customers. Those customers with a good credit rating are generally provided with financing. However, there are many prospective customers who do not have a good credit rating, so called sub-prime borrowers. The number of sub-prime borrowers is so large that many merchants cannot ignore such a vast customer pool.

Used car dealers are one class of merchants that provide financing to sub-prime borrowers. To protect his or her investment, a used car dealer may install a service interruption device in a car sold to a sub-prime borrower. A service interruption device disables a car after a payment code expires and continues to disable the car until a new payment code is provided to the service interruption device. So long as the sub-prime borrower makes his or her payments, the sub-prime borrower is provided with new payment codes. The service interruption device determines whether a new payment code is valid, and if so, the new payment code disables the service interruption device. If the sub-prime borrower becomes delinquent, then the sub-prime borrower is not provided with a new payment code, and the service interruption device disables the car. Service interruption devices have proven to be useful in increasing the on-time payment rate and decreasing both the late payment rate and delinquency rate of sub-prime borrowers.

A problem associated with providing financing to consumers is that many merchants don't want to be in the business of lending and collecting, especially when the merchant is financing the sales. Thus, merchants may desire to sell contracts, or debt instruments, to a third party. However, third parties are reluctant to purchase debt instruments for products having service interruption devices because the third party may incur legal liabilities. For example, the third party may have the responsibility of providing payment codes. And, if a customer is not provided with a payment code when the customer is legally entitled to receive a payment code, the failure to provide the payment code might be considered an effective repossession of the product, which could cause the third party to be legally liable for unlawful/improper repossession.

Thus, a heretofore unaddressed need exists in the industry to allow third parties to acquire debt instruments for products having service interruption devices such that the sub-prime borrowers associated with the acquired debt instruments may continue to receive payment codes.

### SUMMARY OF THE INVENTION

Embodiments of the present invention can be viewed as providing a borrower with payment codes that can be used to prevent a service interruption device from preventing the borrower access to the product that is the subject of a debt instrument. More specifically, the service interruption device is coupled to the purchased product, such as an automobile, in such a manner that if triggered, will prevent the product from being used by the borrower. The present invention operates to automatically generate codes that can be presented to the service interruption device to prevent it from disabling the product for a period of time or until an expiration time. The payment codes are made accessible to the borrower such as through an unassisted borrower accessible system. The codes are generated on a periodic basis, such as prior to the expiration of the previously generated code and likewise made available to the borrower. However, if a triggering event occurs, the automatic generation of the codes is disabled. The triggering event can include a variety of circumstances such as a missed payment, a payment that is late beyond a threshold amount, the borrower not checking in at a required date by either visiting or calling the financer, the borrower moving out of town or out of state, as well as a variety of other events that may give cause of concern regarding the borrowers ability to continue to make payments. Once the triggering event is detected, the code will no longer be generated and eventually, the system interruption device will disable the product. In some embodiments of the invention, if the event giving rise to the trigger is removed, then the code generation can be resumed.

Thus, one embodiment of such a method, among others, can be broadly summarized by the following steps: uploading a future payment code to a self-service customer accessible system, wherein the customer may access the self-service customer accessible system without the assistance of another person; and after the step of uploading the future payment code, confirming that payment for a current payment code has been received.

Another embodiment of such a method, among others, can be broadly summarized by the following steps: (a) determining a payment code distribution time for a future payment code, wherein the future payment code disables a Service Interruption Device coupled to a product associated with a payment plan for a first predetermined period of time starting in the future; (b) at approximately the payment distribution time, distributing the future payment code to a self-service customer accessible system, wherein the customer may access the self-service customer accessible system without the assistance of another person; (c) after time distributing the future payment code, confirming that a payment instrument for a prior payment code has been received, wherein the prior payment code disables the Service Interruption Device for a second predetermined period of time, the second predetermined period of time being earlier in time than the first predetermined period of time; (d) repeating steps (a), (b), and (c), if, and only if, receipt of the payment instrument for the prior payment code is confirmed.

Another embodiment of such a method, among others, can be broadly summarized by the following steps: (a) acquiring debt instruments from a debt instrument originator, wherein the debt instruments are for products having a service interruption device coupled thereto; (b) acquiring from the debt instrument originator information for providing payment codes associated with the acquired debt instruments; (c) enabling payment instruments for the acquired debt instruments to be received through a plurality of payment channels; (d) enabling payment codes to be distributed through a plurality of distribution channels, the plurality of distribution channels including at least one self-service channel, wherein a specific borrower may receive a specific payment code via the self-service channel without the assistance of another person; (e) providing a given future payment code to the at least one self-service channel, wherein the given future payment code is associated with a given debt instruments, wherein the given future payment code disables a given service interruption device for a period of time in the future; (f) after providing the given future payment code to the at least one self-service channel, determining for the given debt instrument whether a payment instrument was received for a prior payment code; and (g) repeating steps (e) if, and only if, the payment instrument for the prior payment code was received.

Other methods, features, and advantages of the present invention will be or become apparent to one with skill in the art upon examination of the following drawings and detailed description. It is intended that all such additional methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 illustrates interactions between borrowers, debt instrument originators, and a debt instrument collector.

FIG. 2 is a block diagram of an exemplary self-service payment code system.

FIG. 3 is block diagram of an account record.

FIG. 4 is a block diagram of a payment code record.

FIG. 5 is a block diagram of an exemplary system that provides payment codes.

FIG. 6 illustrates timelines.

FIG. 7 is a flow chart illustrating steps for selectively providing payment codes.

### DETAILED DESCRIPTION

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

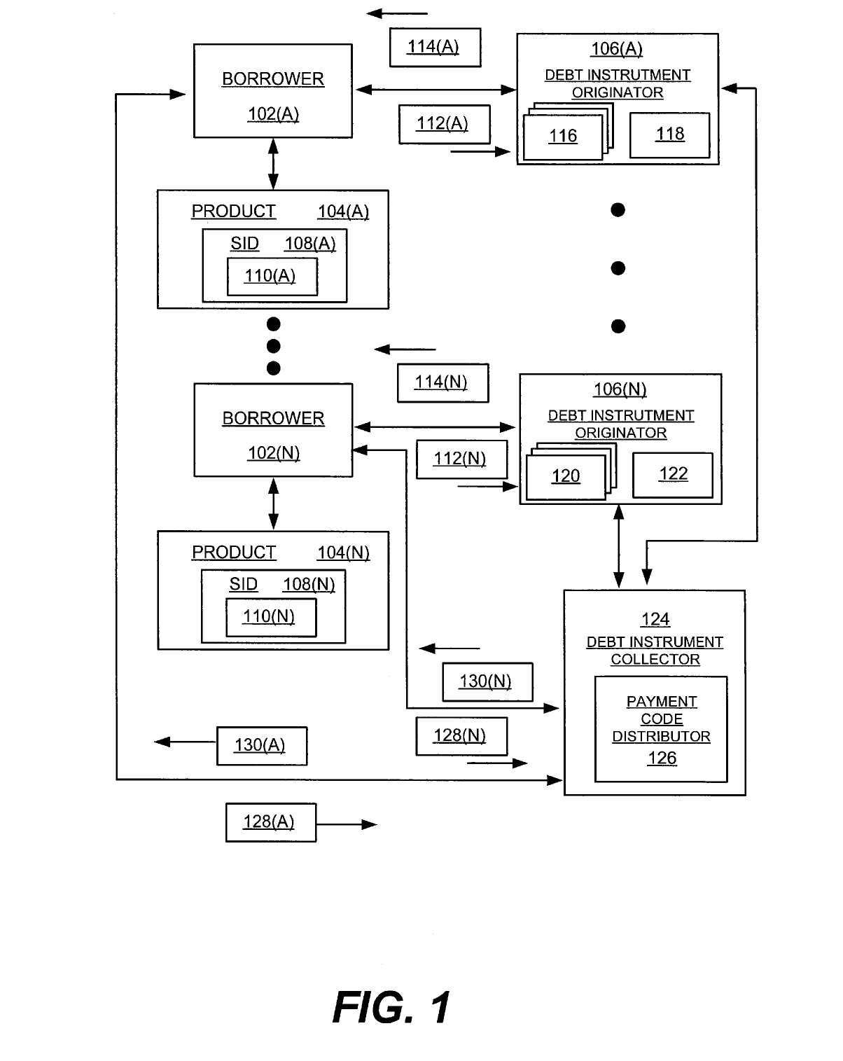

Referring to FIG. 1, borrowers 102(A)-102(N) have purchased tangible products 104(A)-104(N), respectively, on payment plans. The borrowers 102(A)-102(N) may be sub-prime borrowers, i.e., borrowers who do not have good credit, e.g., borrowers with limited or suspect credit histories or bad credit histories. In the embodiment illustrated in FIG. 1, the borrower 102(A) has borrowed money from a debt instrument originator 106(A), and the borrower 102(N) has borrowed money from a debt instrument originator 106(N). It should be noted that in some embodiments, the systems and methods described in this specification are scalable and may accommodate one or more debt instrument originators and/or one or more borrowers.

Typically, the debt instrument originators 106(A)-106(N) may be merchants including retailers who sell goods and or services on a payment plan. For example, the debt instrument originators 106(A)-106(N) may be car dealers, and, for the purposes of this disclosure, car dealers include dealers of new cars, dealers of used cars, and dealers of new and used cars. For the sake of clarity, in some embodiments, the debt instrument originators 106(A)-106(N) will be described herein as car dealers, and the tangible products 104(A)-104(N) will be described herein as cars, which include new cars and/or used cars. However, it should be remembered that the debt instrument originators 106(A)-106(N) are not limited to being dealers of cars, and the tangible products 104(A)-104(N) are not limited to being cars.

Car dealers frequently deal with sub-prime borrowers by, among other things, selling used cars to sub-prime borrowers on a payment plan. Borrowers fall into the sub-prime category for a variety of reasons. For example, a borrower with a credit score such as a FICO score, created by Fair, Issacs and Company, of 660 or lower may be considered as a sub-prime borrower. A borrower with two or more 30-day delinquent payments in the past 12 months or one 60-day delinquency in the past 24 months might be considered a sub-prime borrower. To a car dealer, a sub-prime borrower represents both a potential customer and, in comparison to a prime borrower, a higher risk of delinquency, late payment, and/or default. So as to move his or her inventory, a car dealer may decide to sell a car on a payment plan to a sub-prime borrower, but in order to protect his or her investment in the car, the car dealer may install a Service Interruption Device. Non-limiting examples of Service Interruption Devices for automobiles include starter interrupt devices branded “On Time”, “PASSTIME” and “Payment Guardian”.

In the embodiment illustrated in FIG. 1, the tangible products 104(A)-104(N) each include a Service Interruption Device 108(A)-108(N), respectively. Typically, the Service Interruption Device 108(A) was installed on the tangible product 104(A) by the debt instrument originator 106(A), or by his or her agent, prior to the borrower 102(A) receiving the tangible product 104(A). The Service Interruption Device 108(A) is configured to use a “current payment code” 110(A), which disables the Service Interruption Device 108(A) for a predetermined period of time. The predetermined period of time over which the current payment code 110(A) disables the Service Interruption Device 108(A) normally corresponds to the approximate payment period of the payment plan. Thus, if the payment plan has a payment period of one month, then the current payment code 110(A) disables the Service Interruption Device 108(A) for approximately one month.

Initially, the debt instrument originator 106(A) may input the current payment code 110(A) into the Service Interruption Device 108(A), thereby disabling the Service Interruption Device 108(A) for the first payment period. When the borrower 102(A) makes a payment 112(A), the borrower 102(A) receives a new or future payment code 114(A). The future payment code 114(A) is inputted into the Service Interruption Device 108(A), thereby disabling the Service Interruption Device 108(A) for approximately another payment period. Typically, the cycle of making a payment, receiving a future payment code, inputting the future payment code repeats through the life of the payment plan for the product 104(A). In the event that the borrower 104(A) becomes delinquent (or defaults) on his or her payment plan, e.g., fails to make a payment before a specified time, the borrower 102(A) will not receive another future payment code. Without another payment code 114(A), the SID 108(A) will interrupt the operation of the product 104(A) once the current payment code 110(A) expires. For example, if the product 104(A) is an automobile, then the SID 108(A) may prevent the automobile from starting.

The product 104(N), which the borrower 102(N) has purchased on a payment plan from the debt instrument originator 106(N), also includes a Service Interruption Device 108(N), which has a current payment code 110(N) stored therein. The current payment code 110(N) disables the Service Interruption Device 108(N) for a predetermined period of time, thereby enabling the borrower 102(N) to use the product 104(N) during the predetermined period of time. So long as the borrower 102(N) makes payments 112(N), the borrower 102(N) will receive new/future payment codes 114(N). The new/future payment code 114(N) is inputted into the SID 108(N), thereby enabling the operation of the product 104(N) for another predetermined period of time. In the event that the borrower 104(N) becomes delinquent or defaults on his or her payment plan, the borrower 102(N) will not receive another future/new payment code 1 14(N), and in that case, the SID 108(N) will interrupt the operation of the product 104(N) after the current payment code 110(N) expires.

Typically, the debt instrument originator 106(A) holds debt instruments 116. A debt instrument typically comprises a written agreement between the debt instrument originator 106(A) and a borrower, such as borrower 102(A), specifying the terms and conditions of a payment plan for purchasing a product, such as product 104(A). The debt instrument originator 106(A) may also have a payment code database 118, which may comprise payment codes for Service Interruption Devices that are coupled to products that are sold by the debt instrument originator 106(A). When a product is sold on a payment plan and the product includes a Service Interruption Device, the Service Interruption Device is active for the life of the debt instrument. Once the product has been paid off, the Service Interruption Device may be de-activated and/or may be removed from the product.

In one embodiment, the debt instrument originator 106(N) holds debt instruments 120 between the debt instrument originator 106(N) and customers of the debt instrument originator, such as, but not limited to, borrower 102(N), who have purchased products from the debt instrument originator 106(N) on a payment plan. The debt instrument originator 106(N) may also have a payment code generator 122. The payment code generator 122 may include, among other things, keys for generating payment codes. Typically, a key is provided as an input into an algorithm, which then generates a payment code.

Generally, the debt instrument originators 106(A)-106(N) are not primarily in the business of lending money. Instead, their primary business is selling products 104(A) and 104(N), respectively. The debt instrument originators 106(A)-106(N) may have significant capital tied up in debt instruments 116 and 120, respectively. In order to free up their capital, the debt instrument originators 106(A)-106(N) may sell the debt instruments 116 and 120, respectively, to a debt instrument collector 124. The debt instrument originators 106(A)-106(N) may use the money from the sale of the debt instrument originators 106(A)-106(N) to, among other things, purchase more inventory.

When the debt instrument collector 124 purchases debt instruments, in addition to receiving the debt instruments 116 and 120, the debt instrument collector 124 receives, among other things, information for providing payment codes for purchased debt instruments. For example, the debt instrument originator 106(A) provides the debt instrument collector 124 with payment codes associated with transferred debt instruments. Similarly, the debt instrument originator 106(N) provides the debt instrument collector 124 with keys and algorithms associated with purchased debt instruments.

The debt instrument collector 124 includes a payment code distributor 126. The payment code distributor 126 includes, among other things, software, hardware, and firmware for, among other things, receiving payments 128(A)-128(N) or payment notifications and providing future payment codes 130(A)-130(N). Typically, the debt instrument collector 124 acquires debt instruments from multiple debt instrument originators, and the debt instrument originators typically have their own business models and methods of operation. Consequently, the debt instruments 116 acquired from the debt instrument originator 106(A) will generally have different obligations and terms than the debt instruments 120 acquired from the debt instrument originator 106(N). Because a given debt instrument defines the legal rights and obligations between a given borrower and the holder of the given debt instrument, the debt instrument collector 124 must operate in a manner consistent with the given debt instrument. In other words, when the debt instrument collector 124 acquires a given debt instrument, the debt instrument collector 124 must continue to service the given debt instrument in the manner stipulated in the given debt instrument, unless the given debt instrument authorizes the holder of the given debt instrument of change the manner in which the given debt instrument is serviced. Because the debt instrument originators 106(A)-106(N) are typically independent debt instrument originators having differing methods of operations, the debt instruments 116 and 120 are normally non-uniform having different terms and condition, and consequently, the debt instrument collector 124 may have to service acquired debt instruments in multiple ways. For example, the debt instruments 116 may stipulate that payments are due on the first day of each month and are overdue if the payments have not been paid by no later than the fifth day of each month. Whereas, the debt instruments 120 may stipulate that payments are due on Monday of each week and are overdue if the payments have not been paid any later than the Wednesday of each week. Similarly, the debt instruments 116 and 120 may provide for different methods of payments, e.g., cash, check, money order, credit, etc. Similarly, the debt instruments 116 and 120 may provide for different channels of payments, e.g., sending payments by mail, paying at a self-service kiosk, paying at a storefront, paying at the respective debt instrument originator, etc. In addition, the debt instruments 116 and 120 may provide for different channels for providing payment codes, e.g., providing payment codes telephonically, providing payment codes over an internet system, providing payment codes through an agent, etc.

The payment code distributor 126 is configured to receive the payments 128(A) and 128(N), or payment notifications/confirmations, through a variety of payment channels and provide the payment codes 130(A)-130(N) through a variety of distribution channels in accordance with debt instruments 116 and 120. Non-limiting examples of payment channels include: receiving payments and/or payment instruments through the mail, and/or delivery service; electronic transfers such as, but not limited to, telephonic transfers, internet transfers, and wire transfers; self-service kiosks; and store fronts. Non-limiting examples of payment code distribution channels include: telephonic systems including call center systems, Interactive Voice Response systems (IVR), and messaging systems such as SMS; electronic delivery including email and web pages; self-service kiosks; and teller assistance.

Typically, the debt instrument collector 124 acquires debt instruments 116 and 120 from multiple debt instrument originators 106(A) and 106(N), respectively, and frequently, different debt instrument originators may use different types of Service Interruption Devices, which may operate differently. Some types of Service Interruption Devices may use a payment code to generate a result, and then the Service Interruption Device can determine if the result is correct. If the result is correct, the Service Interruption Device is temporarily disabled. Some types of Service Interruption Devices may store reference payment codes. When a future payment code is inputted into the Service Interruption Device, the Service Interruption Device may selectively compare the inputted payment code against one or more of the reference payment codes. If the Service Interruption Device finds a match, the Service Interruption Device is then temporarily disabled. In some embodiments, after comparing the inputted payment code to one or more of the reference codes, the Service Interruption Device may delete the matched reference payment code so that the same inputted payment code cannot be reused. Alternatively, in some embodiments, during the comparison of the inputted payment code against the reference payment codes, the Service Interruption Device may ignore previously matched reference payment codes, thereby preventing the repeat usage of an inputted payment code.

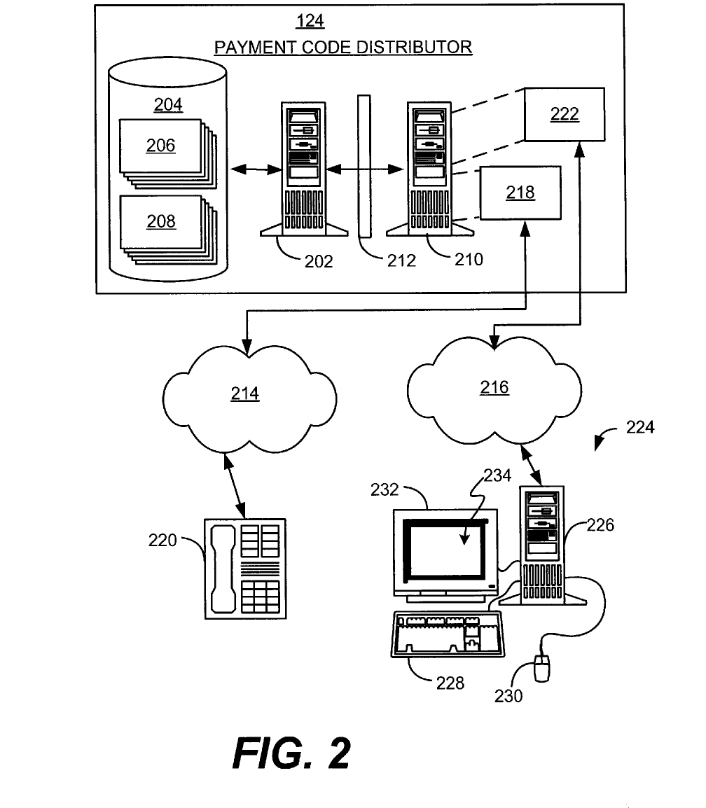

Referring to FIG. 2, in one embodiment, the payment code distributor 124 includes a first server 202 that is in communication with a database 204. The database 204 can include any one or combination of volatile memory elements (e.g., RAM, such as DRAM, SRAM, SDRAM, etc.) and nonvolatile memory elements (e.g., ROM, flash memory, etc.). Moreover, the database 204 may incorporate electronic, magnetic, optical, and/or other types of storage media. Note that the database 204 can have a distributed architecture, where various components are situated remote from one another, but can be accessed by the server 202.

Among other things, the database 204 has account records 206 and payment code records 208 stored therein. A given account record 206 corresponds to a given payment plan and may include information such as, but not limited to, the name of a borrower and/or other borrower identification information such as social security number, and payment plan information such as, but not limited to, the term of the payment plan, interest rate, channels for receiving payment, channels for distributing payment codes, etc. In addition, a given account record 206 may include information identifying a specific Service Interruption Device, information identifying a specific debt instrument originator, and payment history.

A given payment code record 208 may be associated with a given account record 206. The given payment code record 208 may include payment codes for the payment plan of the given account record 206. Similarly, the given payment code record 208 may include keys, and/or other information, for generating payment codes for the payment plan of the given account record 206.

The server 202 is able to access the database 204 and selectively provide, among other things, future payment codes to a second server 210. Typically, the future payment codes are associated with account information such as, but not limited to, account identifying information. The first server 202 and the database 204 may be behind a firewall 212. The firewall 212 protects the database 204 from unauthorized access. The second server 210 may be in communication with a telephony network 214 and with a distributed communication network 216. As non-limiting examples, the telephony network 214 may be a Public Switched Telephone Network (PTSN) and the communication network 216 may be the Internet.

In some embodiments, the server 210 may comprise a self-service customer accessible system, which may include an Interactive Voice Response (IVR) module 218. The IVR module 218 may be embodied in hardware, firmware, and/or software and provides IVR functionality. A borrower may use a telephone 220 to communicate with the server 210 via the telephony network 214 and the IVR module 218. The IVR module 218 may prompt the borrower to provide information such as, but not limited to, account identifying information. In response to receiving account identifying information, the server 210 may respond by providing the borrower with a future payment code.

In some embodiments, the server 210 includes a communication network interface 222. Typically, the communication network interface 222 includes the hardware, firmware, and/or software for providing access to the server 210 via the communication network 216. In some embodiments, the communication network interface 222 may be configured to provide Internet access to borrowers. Typically, a borrower may use a network device 224 to access the server 210 via the communication network 216 and communication network interface 222. Non-limiting examples of network devices include computer systems, Personal Digital Assistants, and Tablets. The network device 224 illustrated in FIG. 2 is comprised of a computer 226, and various input/output devices such as keyboard 228, mouse 230 and monitor 232. Monitor 232 includes a cathode-ray tube for displaying content 234.

In some embodiments, the server 210 provides web pages to the computer 226 which are displayed on the monitor 232. Typically, the server 210 may provide a borrower with a login-page, which may require the borrower to enter a username and password. In some embodiments, the borrower may be provided with web pages that allow the borrower to make a payment over the communication network 216. The borrower may be provided with a plurality of payment options such as withdrawing the payment amount from a checking account, from a savings account, or charging the payment amount against a credit card, debit card, and/or a pre-paid card. In addition to allowing borrowers to make payments, the server 210 may be configured to provide future payment codes to borrowers. After a borrower has logged into the server 210, the borrower may request a new/future payment code. In response to the request, the server 210 may provide a web page to the computer 226, and the web page, which may include a new/future payment code, is displayed on the monitor 232.

It should be noted that methods described above for providing borrowers with payment codes are exemplary and are non-limiting. In other embodiments, the server 210 may be configured to provide payment codes to borrowers via messaging systems such as, but not limited to, Short Message Service (SMS). The server 210 may also be configured to provide payment codes via an electronic-mail system.

It should be further noted that in some embodiments, authorized personnel and/or devices may access the server 202 to provide payment codes. In a first non-limiting example, tellers at a storefront may be authorized to accept payment and access the server 202. The tellers may be authorized to access the server 202 to provide borrowers with payment codes. In another non-limiting example, self-service kiosks (not shown) may be configured to access the server 202, and the Self-service kiosks may be used to accept payments and provide payment codes.

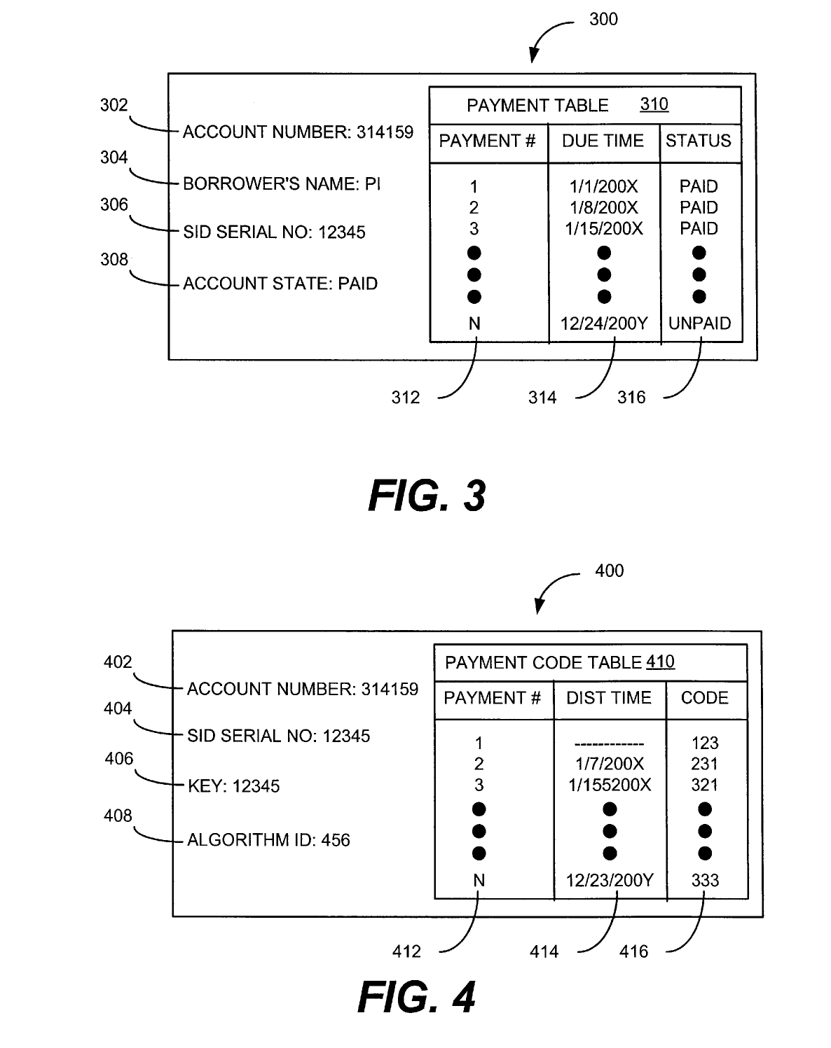

FIG. 3 illustrates exemplary information carried in an account record 300. It should be noted that a given account record may carry more or less information. The account record 300 includes multiple fields 302, 304, 306, and 308. The field 302 includes an account number. The account number is used to identify the account. Field 304 includes a borrower's name. When more than one person has signed a debt instrument, the co-signers may also be included in field 304. Field 306 carries an identifier for a Service Interruption Device. The identifier may be a serial number. Field 308 carries account state information. Possible states for an account include “paid,” “unpaid,” “delinquent,” and “overdue.” In some embodiments, there exist other account states. The information carried in the field 308 may correspond to one of the above account states or other possible states.

The account record 300 may also carry a payment table 310. The payment table 310 is comprised of a payment number column 312, a payment due time column 314, and payment status column 316. The payment number column 312 lists the scheduled payments for paying off the loan for the given account. The payment due time column 314 lists the due times of the payments, and the payment status column lists the payment status, paid or unpaid, for the payments.

FIG. 4 illustrates exemplary information carried in a payment code record 400. It should be noted that a given payment code record may carry more or less information.

The payment code record 400 may include multiple fields 402, 404, 406, and 408. The field 402 includes an account number, and the field 404 carries an identifier such as, but not limited to, a serial number for a Service Interruption Device. The identifier may be a serial number.

In some embodiments, the payment code record 400 may include a “code key” that is carried in field 406 and an “algorithm identifier” that is carried in field 408. The algorithm identifier is used to retrieve a specific algorithm for generating a payment code. It should be remembered that the debt instrument collector 124 may have acquired debt instruments from multiple debt instrument originators 106(A)-106(N) and that the different debt instrument originators 106(A)-106(N) may have used different algorithms for generating payment codes, and consequently, the debt instrument collector 124 may have collected multiple algorithms in order to provide different borrowers with their respective payment codes. Upon retrieving the identified algorithm, the algorithm uses the code key and possibly other information to generate a future payment code.

In some embodiments, the payment code record 400 may include a payment code table 410. The payment code table 410 is comprised of a payment number column 412, a payment code distribution time column 414, and payment code column 416. The payment number column 412 lists the scheduled payments for paying off the loan for the given account. The payment code distribution time column 414 lists the times for which payment codes are distributed to the server 210, and the payment code column 416 lists the payment codes for the payments.

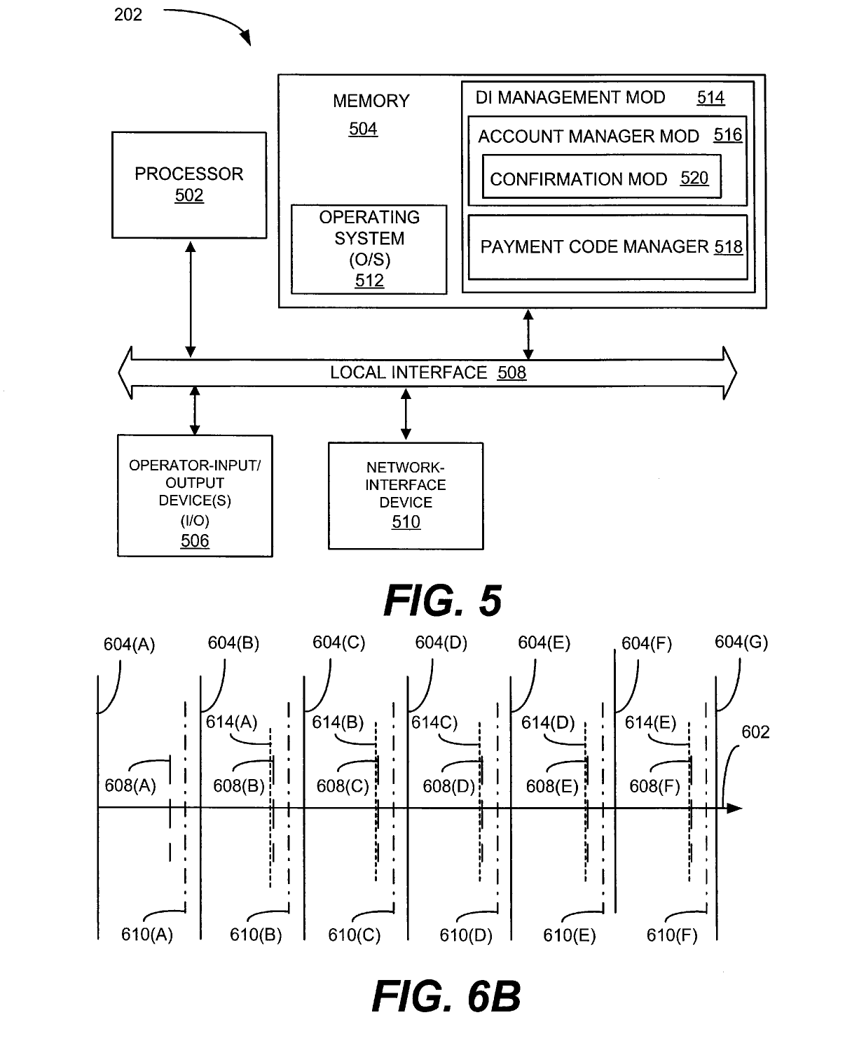

FIG. 5 is a schematic diagram illustrating an embodiment of the server 202 of FIG. 2. Generally, in terms of hardware architecture, as shown in FIG. 5, server 202 includes processor 502, memory 504 and one or more user input and/or output (I/O) devices 506 (or peripherals) that are communicatively coupled via a local interface 508.

The local interface 508 can be, for example but is not limited to, one or more buses or other wired or wireless connections, as is known in the art. The local interface 508 may have additional elements, which are omitted for simplicity, such as controllers, buffers (caches), drivers, repeaters, and receivers, to enable communications. Further, the local interface 508 may include address, control, and/or data connections to enable appropriate communications among the aforementioned components.

Processor 502 is a hardware device for executing software, particularly that stored in memory 504. The processor 502 can be any custom made or commercially available processor, a central processing unit (CPU), an auxiliary processor among several processors, a semiconductor based microprocessor (in the form of a microchip or chip set), or generally any device for executing software instructions.

The memory 504 can include any one or combination of volatile memory elements (e.g., RAM, such as DRAM, SRAM, SDRAM, etc.) and nonvolatile memory elements (e.g., ROM, flash memory, etc.). Moreover, the memory 504 may incorporate electronic, magnetic, optical, and/or other types of storage media. Note that the memory 504 can have a distributed architecture, where various components are situated remote from one another, but can be accessed by the processor 502.

The user I/O devices 506 may include input devices, for example but not limited to, a keyboard, mouse, scanner, microphone, a touch sensitive display etc. Furthermore, the user I/O devices 506 may also include output devices, for example but not limited to, a printer, display, etc. I/O devices may further include devices that communicate both inputs and outputs, for instance but not limited to, a modulator/demodulator (modem; for accessing another device, system, or network), a radio frequency (RF) or other transceiver, a telephonic interface, a bridge, a router, etc. One or more of these communication devices may be included in a network interface device 510, which enables server 202 to communicate with the database 204 and server 210.

Software stored in memory 504 may include one or more separate programs, each one of which comprises an ordered listing of executable instructions for implementing logical functions. In the example of FIG. 5, the software in the memory 504 includes operating system 512 and debt instrument management module 514. Among other things, operating system 512 essentially controls the execution of debt instrument management module 514 and provides scheduling, input-output control, file and data management, memory management, and communication control and related services.

Debt instrument management module 514 may be a source program, executable program (object code), script, or any other entity comprising a set of instructions to be performed. When implemented as a source program, debt instrument management module 514 is translated via a compiler, assembler, interpreter, or the like, which may or may not be included within the memory 504, so as to operate properly in connection with the O/S 512. Furthermore, debt instrument management module 514 can be written in one or more object oriented programming languages, which have classes of data and methods, or procedure programming languages, which have routines, subroutines, and/or functions.

The debt instrument management module 514 includes an account manager module 516 and a payment code manager module 518. Among other things, the account manager module 516 uses the account records 206 to manage borrowers' accounts. The account manager module 516 may include logic for, among other things, determining when payments are due, determining whether payments have been received, determining whether a payment is overdue, determining whether a payment is overdue and is delinquent, and the account manager module 516 may include a confirmation module 520. The confirmation module 520 may include the logic for confirming that payments have been received. In some embodiments, the debt instrument management module 514 may include logic for updating account records 206 and payment code records 208.

In some embodiments, when payments or payment instruments are received, the confirmation module 520 updates the account records 206 to “paid.” By way of non-limiting examples, cash, checks, money orders, debit authorizations, and credit authorizations may be considered to be payment instruments. For a given payment instrument having a specific monetary value, payment is received when the debt instrument collector 124 has received the actual monetary value of the given payment instrument or has received confirmation from another receiving service that payment has been received. When a borrower submits a payment instrument to the debt instrument collector 124, the confirmation module 520 may be configured to update the account record to reflect that a given payment has been received, e.g., changing the state of one of the listings in the payment status column 316 from “unpaid” to “paid.” However, if the received payment instrument is not honored, i.e., the debt instrument collector 124 does not receive the actual monetary value for the received payment instrument, then the confirmation module may update the account record 300. Typically, the confirmation module 520 may revert the aforementioned listing in the payment status column back to “unpaid” or change the listing to “overdue” or another status. Similarly, the confirmation module 520 may be configured to update the account record 300 such that the account state 308 is changed to “overdue,” or “delinquent,” or another state.

In some embodiments, the confirmation module 520 may be configured to update the account record 300 one or more times during a payment period. For example, the confirmation module 520 may change the account state field 308 from “paid” to “overdue,” when a payment has not been received by a specified time. The confirmation module 520 may then change the account state field 308 from “late” to “delinquent” if the payment has not been received by a second specified time. The confirmation module 520 may also change the account state from “late” or “delinquent” to “paid” once payment or a payment instrument has been received.

The payment code manager 518 may include logic for providing the server 210 with future payment codes. In some embodiments, the account manager module 516 may prompt the payment code manager 518 to provide future payment codes. In other embodiments, the payment code manager 518 may include the logic for determining when to provide the server 210 with future payment codes. In some embodiments, the payment code manager 518 may be configured to use the account records 206 and the payment code records 208 for providing payment codes. For example, for a given account, the payment code manager 518 may check the field 308 for the account status to see whether to provide a future payment code for a given account. If the account status is paid, then payment code manager 518 may then retrieve the payment code record corresponding to the given account and use information from the retrieved payment code record to generate and/or retrieve a payment code.

In some embodiments, the payment code manager 518 may receive a payment code distribution list from the account manager module 516. The payment code manager 518 may use the payment code distribution list in conjunction with the payment code records 208 to provide payment codes for the accounts included in the payment code distribution list. In an alternative, the account manager module 516 may provide the payment code manager 518 with a payment code exclusion list, wherein payment codes for the accounts identified in the payment code exclusion list are not provided to the server 210.

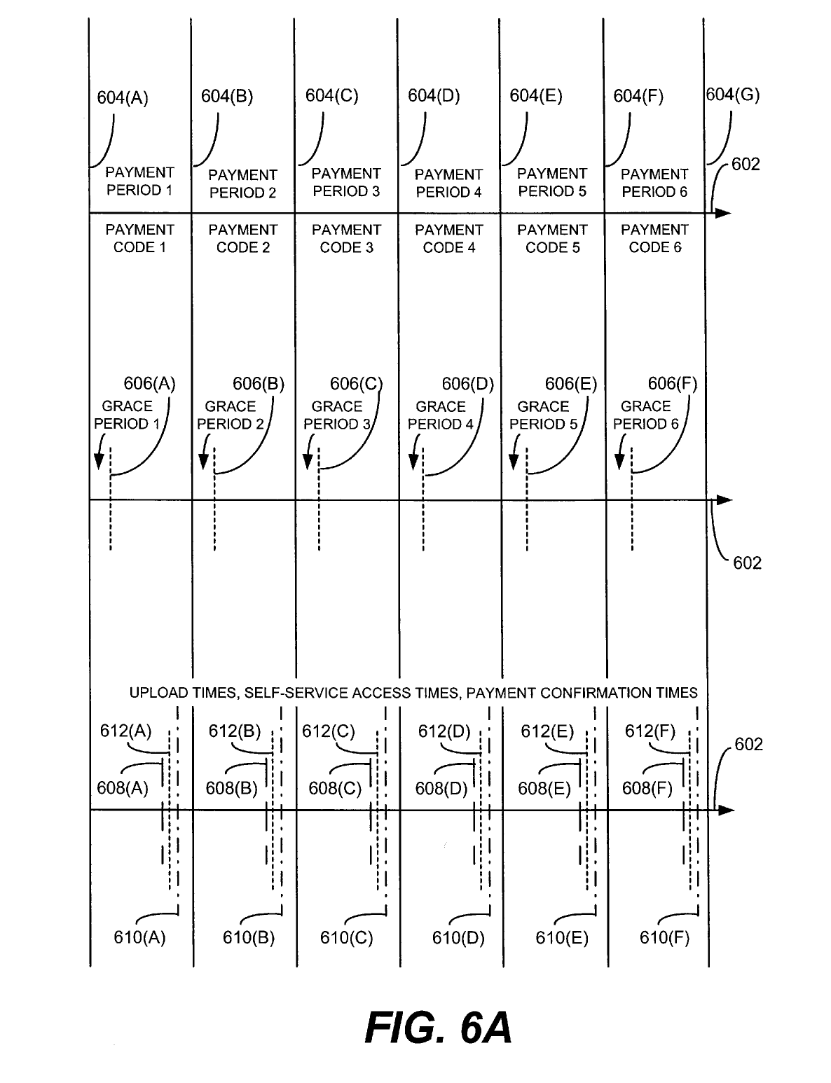

In FIG. 6, the horizontal lines 602 are time lines and the vertical lines represent various times at which actions by either a specific borrower or the debt instrument collector are due. These times are normally defined by a debt instrument.

The vertical lines 604(A)-604(G) denote payment due times, i.e., the times by which the borrower must make a payment. The time span between two adjacent payment due times is defined as a payment period. Each one of the payment periods has a payment code associated with it. The payment code associated with a specific payment period disables the Service Interruption Device during the specific payment period. For a given payment code, the first temporal due time denotes the time on which the payment code becomes active, and the second temporal due time denotes the time on which the payment code expires. For example, the payment code 1 has an activation time corresponding to the line 604(A) and an expiration time corresponding to the line 604(B).

In some embodiments, borrowers are given a grace period for providing a new payment code. During a grace period, a Service Interruption Device continues to be disabled by a previously provided payment code such as the “current” payment code. For example, payment code 2, which disables a Service Interruption Device during payment period 2, which is defined by due times 604(B) and 604(C), is due to expire at the payment due time denoted by line 604(C). However, in this example, the borrower is given a grace period that extends each payment code beyond the expiration time. The end of the grace period for payment period 2 is denoted by the vertical line 606(C). The vertical lines 606(A)-606(F) denote the times at which the grace periods 1 through grace periods 6, respectively, expire. Typically, the length of a grace period is proportional to the length of a payment period. For example, for monthly payment periods, the grace periods might be one week, whereas, for weekly payment periods, the grace periods might be a couple or several days.

The vertical lines 608(A)-608(F) represent the times on which a future payment code is distributed to server 210. Specifically, line 608(A) represents the time on which payment code 2 is distributed to the server 210, and line 608(F) represents the time on which payment code 7 (not shown) is distributed to the server 210.

The vertical lines 610(A)-610(F) represent the times at which future payment codes may be accessed by a customer using a self-service customer accessible system. For example, payment code 2 may be accessed on server 210 after or on the time denoted by vertical line 610(A). Similarly, the future payment code 7 (not shown) may be accessed after or on the time denoted by line 610(F). Typically, for a given future payment code, the given future payment code is accessible prior to the activation time of the given future payment code.

The vertical lines 612(A)-612(F) represent the times on which receipt of a payment or payment instrument for the prior (or current) payment code is confirmed. Specifically, line 612(A) represents the time on which payment for payment code 1 is confirmed, and line 612(F) represents the time on which payment for payment code 6 is confirmed. In this example, payment for a given current payment code is confirmed after distributing the subsequent future payment code. It should be noted that in some embodiments, the payment confirmation times, which are represented by lines 612(A)-612(F), may be immediately after the payment code distribution times, which are represented by lines 608(A)-608(F).

In some embodiments, a given payment confirmation time may be after the current payment due time, which is represented by one of the lines 604(A)-604(F), and immediately preceding the next payment code distribution time, which is represented by one of the lines 608(A)-608(F). For example, referring to FIG. 6B, in one embodiment, the lines 614(A)-614(E) represent payment confirmation times. The line 614(A) represents the time at which receipt of payment, or payment instrument, for payment code 1 is to be confirmed. Similarly, the line 614(E) represents the time at which receipt of payment, or payment instrument, for payment code 5 is to be confirmed. In other words, confirmation of receipt of payment (or receipt of payment instrument) for a given payment code may occur, in some embodiments, in the time span defined as after the distribution time of the next payment code and prior to the distribution time for the next-to-next distribution time.

In some embodiments, the debt instrument management module 514 may be configured to check the database 204 on a daily or periodic basis. The debt instrument manager module 514 may use the account records 206 and/or payment code records 208 to identify accounts for which new payment codes should be provided to the server 210. The debt instrument manager module 514 may be configured to distribute the future payment codes for the identified accounts. Then, at a later time, the debt instrument manager module 514 may confirm for a given account that payment for the current payment code has been received.

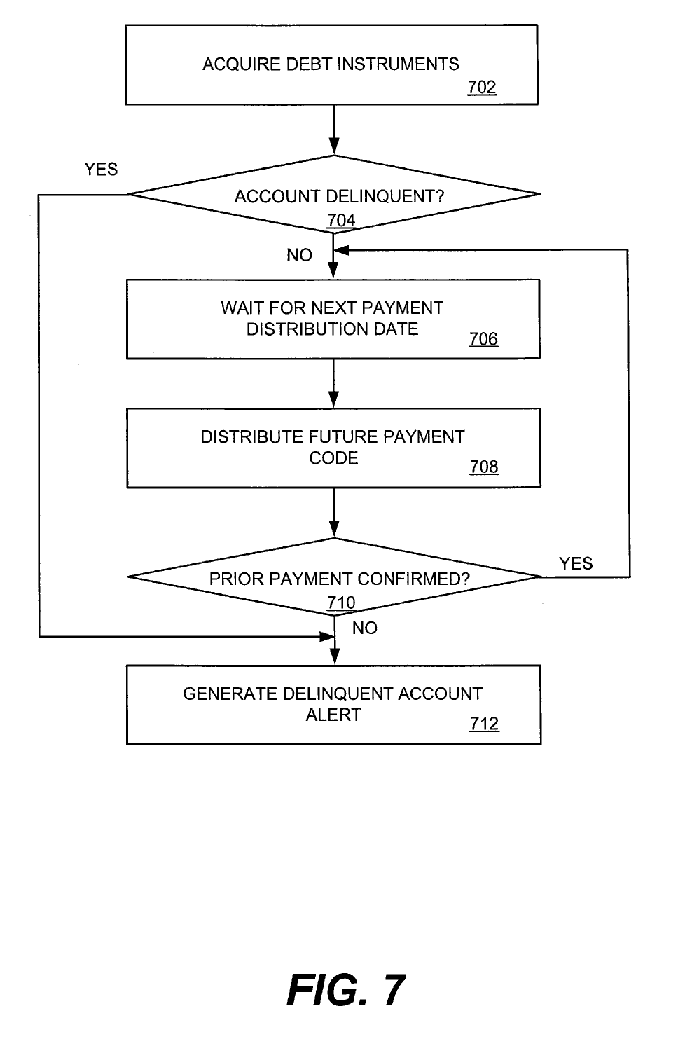

FIG. 7 illustrates an exemplary flow chart that may be implemented by the debt instrument collector 124 and/or by the debt instrument manager module 514. In step 502, the debt instrument collector 124 acquires a debt instrument from a debt instrument originator. In step 704, the debt instrument manager module 514 determines whether the newly acquired debt instrument is delinquent. If the newly acquired debt instrument is delinquent, the debt instrument manager module 514 proceeds to step 712 and generates a delinquent account alert. A delinquent account is not provided with new/future payment codes until the account is brought up to date.

In step 706, the debt instrument management module 514 waits for the next payment distribution time for the account. In some embodiments, the debt instrument collector may have acquired so many debt instruments that on any given day, at least some of the acquired debt instruments have a payment distribution time on that given time. Furthermore, in some embodiments, at a given time, some of the acquired debt instruments may have a payment code distribution time at a first specific time, and other acquired debt instruments may have a payment code distribution time on the same day but at a second specific time.

In step 708, the future payment code for the account is distributed to the server 210. In step 710, the debt instrument management module 514 confirms that actual payment, or receipt of a payment instrument, for a prior payment code or current payment code has been received by the debt instrument collector 124. If actual payment, or receipt of a payment instrument, for the prior payment code or current payment code has not been received, then the debt instrument management module 514 proceeds to step 712. On the other hand, if actual payment, or receipt of a payment instrument, for the prior payment code or current payment code is confirmed, then the debt instrument management module 514 returns to step 706.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method of providing payment codes to a customer, the method comprising the steps of:
(a) determining a payment code distribution time for a future payment code, wherein the future payment code disables a Service Interruption Device coupled to a product associated with a payment plan for a first predetermined period of time starting in the future;
(b) at approximately the payment code distribution time, distributing the future payment code to a self-service customer accessible system, wherein the customer may independently access the self-service customer accessible system;
(c) after distributing the future payment code, confirming that a payment instrument for a prior payment code has been received, wherein the prior payment code disables the Service Interruption Device for a second predetermined period of time, the second predetermined period of time being later in time than the first predetermined period of time;
(d) repeating steps (a), (b), and (c), if, and only if, receipt of the payment instrument for the prior payment code is confirmed.

2. The method of claim 1, further including the step of:
responsive to confirming that the payment instrument for the prior payment code has not been received, generating a delinquency alert.

3. The method of claim 1, wherein the step of distributing the future payment code includes providing the payment code to a self-service telephony system.

4. The method of claim 3, wherein the self-service telephony system comprises an Interactive Voice Recognition system.

5. The method of claim 1, wherein the step of distributing the future payment code includes providing the payment code to a self-service Internet distribution device.

6. The method of claim 5, the self-service Internet distribution device provides the customer with a web page having content that includes the future payment code therein.

7. A method of providing payment codes to a customer, the method comprising the steps of:
uploading a future payment code to a self-service customer accessible system, wherein the customer may access the self-service customer accessible system without the assistance of another person; and
after the step of uploading the future payment code, confirming that payment for a current payment code has been received.

8. The method of claim 7, wherein self-service customer accessible system comprises a self-service telephony system.

9. The method of claim 8, wherein the self-service telephony system comprises an Interactive Voice Recognition system.

10. The method of claim 7, wherein self-service customer accessible system comprises a self-service Internet distribution device.

11. The method of claim 10, the self-service Internet distribution device provides the customer with a web page having content that includes the future payment code therein.

12. A method of managing a portfolio of debt instruments, the method comprising the steps of:
(a) acquiring debt instruments from a debt instrument originator, wherein the debt instruments are for products having a service interruption device coupled thereto;
(b) acquiring from the debt instrument originator information for providing payment codes associated with the acquired debt instruments;
(c) enabling payment instruments for the acquired debt instruments to be received through a plurality of payment channels;
(d) enabling payment codes to be distributed through a plurality of distribution channels, the plurality of distribution channels including at least one self-service channel, wherein a specific borrower may receive a specific payment code via the self-service channel without the assistance of another person;
(e) providing a given future payment code to the at least one self-service channel, wherein the given future payment code is associated with a give debt instruments, wherein the given future payment code disables a given service interruption device for a period of time in the future;
(f) after providing the given future payment code to the at least one self-service channel, determining for the given debt instrument whether a payment instrument was received for a prior payment code; and
(g) repeating steps (e) if, and only if, the payment instrument for the prior payment code was received.

13. The method of claim 12, further including the steps of (e), (f), and (g) for each of the acquired debt instruments.

14. A method for providing payment codes for disabling a service interruption device coupled to a product being purchased under a payment plan with periodic payments, the method comprising the steps of:
automatically generating a first payment code, the first payment code being operative to disable a service interruption device coupled to the product until a first expiration time;
providing access to the first payment code through a self-service customer accessible system;
automatically generating a next payment code on a periodic basis;
providing access to the next payment code through a self-service customer accessible system;
detecting the occurrence of a triggering event;
upon detection of the triggering event, suspending the step of automatically generating the next payment code;
detecting a remediation of the triggering event;
upon detection of the remediation of the triggering event, continuing the step of automatically generating a next payment code.

15. The method of claim 14, wherein the step of detecting the occurrence of a triggering event further comprises detecting the delinquency of the periodic payments.

16. The method of claim 15, wherein the step of detecting the remediation of the triggering event further comprises detecting the remediation of the delinquency of the periodic payments.

17. The method of claim 14, wherein the periodic payments have a due date and the step of detecting the triggering event further comprises detecting the passing of a due date without having received a payment.

18. The method of claim 17, wherein the step of detecting the remediation of the triggering event further comprises detecting the reception of a payment associated with the passed due date.

19. A method for providing payment codes for disabling a service interruption device coupled to a product being purchased under a payment plan with periodic payments, each payment having a due date, the method comprising the steps of:
automatically generating a first payment code, the first payment code being operative to disable a service interruption device coupled to the product until a first expiration time;
providing access to the first payment code through a self-service customer accessible system;
automatically generating a next payment code on a periodic basis;
providing access to the next payment code through a self-service customer accessible system;
detecting the occurrence of a payment due date without having received the payment;
upon detection of the missed payment, suspending the step of automatically generating the next payment code;
receiving the missed payment; upon receiving the missed payment, continuing the step of automatically generating a next payment code.
